(19) United States
(12) Patent Application Publication
(10) Pub. No.: US 2017/0132042 A1
(43) Pub. Date: May 11, 2017

(54) SELECTING A PLATFORM CONFIGURATION FOR A WORKLOAD

(71) Applicant: Hewlett Packard Enterprise Development LP, Houston, TX (US)

(72) Inventor: Ludmila Cherkasova, Sunnyvale, CA (US)

(21) Appl. No.: 15/116,119

(22) PCT Filed: Apr. 23, 2014
(86) PCT No.: PCT/US2014/035101

§ 371 Date: Aug. 2, 2016

(51) Int. Cl. G06F 9/50; G06F 9/48

(52) U.S. Cl. CPC G06F 9/505; G06F 9/5077; G06F 9/4887

(57) ABSTRACT

Schedules that satisfy at least one objective for a workload of jobs for execution on respective different platform configurations is determined, where the different platform configurations differ in at least one resource attribute. Performance of the workload of jobs on the different platform configurations is simulated according to the respective schedules. For the workload of jobs, a platform configuration is selected from the different platform configurations, based on results of the simulation.

### BACKGROUND

A cloud infrastructure can include various resources, including computing resources, storage resources, and/or communication resources, that can be rented by customers (also referred to as tenants) of the provider of the cloud infrastructure. By using the resources of the cloud infrastructure, a tenant does not have to deploy the tenant's own resources for implementing a particular platform for performing target operations. Instead, the tenant can pay the provider of the cloud infrastructure for resources that are used by the tenant. The “pay-as-you-go” arrangement of using resources of the cloud infrastructure provides an attractive and cost-efficient option for tenants that do not desire to make substantial up-front investments in infrastructure.

### BRIEF DESCRIPTION OF THE DRAWINGS

Some example implementations are described with respect to the following figures.

FIG. 1 is a flow diagram of an example platform configuration selection process according to some implementations.

FIG. 2 is a block diagram of an example arrangement that includes a cloud infrastructure and a mechanism to select a platform configuration of resources of the cloud infrastructure to use for a target workload of a tenant, in accordance with some implementations.

FIG. 3 is a block diagram of an example control system according to some implementations.

FIG. 4 is a flow diagram of an example iterative process of estimating completion times that includes generating schedules of jobs and replaying the jobs using a simulator, in accordance with some implementations.

FIGS. 5 and 6A-6B illustrate execution orders of jobs, according to some examples.

FIG. 7 is a schematic diagram of a scheduler placing jobs of a workload into a scheduling queue, according to some implementations.

### DETAILED DESCRIPTION

A cloud infrastructure can include various different types of resources that can be employed by a tenant for deploying a system for performing a workload of the tenant. A tenant can refer to an individual or an enterprise (e.g. a business concern, an educational organization, or a government agency). The resources of the cloud infrastructure are available over a network, such as the Internet, a local area network (LAN), a wide area network (WAN), a virtual private network (VPN), and so forth.

A selected set of resources of the cloud infrastructure form a specific platform configuration that is usable for performing the workload of the tenant. Selections of different combinations of resources form different platform configurations. A platform configuration can refer to an arrangement of resources that together can perform the workload.

In the ensuing discussion, reference is made to computing resources that are used for performing computing tasks. However, it is noted that techniques or mechanisms according to some implementations can be applied to other types of resources that can be available in a cloud infrastructure, including storage resources and/or communication resources. Storage resources can be used for storing data, while communication resources can be used for communicating data between network elements.

Computing resources can include computing nodes, where a “computing node” can refer to a computer, a collection of computers, a processor, or a collection of processors. A tenant can select a cluster of computing nodes to use for performing a workload. Depending on the workload to be performed, the tenant can select clusters of different sizes. A larger cluster size includes a larger number of computing nodes.

In addition, in some implementations, computing resources can also be categorized into computing resources of different processing capacity (resources of different sizes). As examples, the computing resources can include virtual machines (formed of machine-readable instructions) that emulate a physical machine. A virtual machine can execute an operating system and applications like a physical machine. Multiple virtual machines can be included in a physical machine, and these multiple virtual machines can share the physical resources of the physical machine. Virtual machines can be categorized into different sizes, such as small, medium, and large. A small virtual machine has a processing capacity that is less than the processing capacity of a medium virtual machine, which in turn has less processing capacity than a large virtual machine. As examples, a large virtual machine can have twice the processing capacity of a medium virtual machine, and a medium virtual machine can have twice the processing capacity of a small virtual machine. A processing capacity of a virtual machine can refer to a central processing unit (CPU) and memory capacity, for example.

A provider of a cloud infrastructure can charge different prices for use of different resources. For example, the provider can charge a higher price for a large virtual machine, a medium price for a medium virtual machine, and a lower price for a small virtual machine. In a more specific example, the provider can charge a price for the large virtual machine that is twice the price of the medium virtual machine. Similarly, the price of the medium virtual machine can be twice the price of a small virtual machine. Note also that the price charged for a platform configuration can also depend on the amount of time that resources of the platform configuration are used by a tenant.

Although specific relative prices and processing capacities of virtual machines of different sizes are noted above, different relative prices and different relative processing capacities can be employed in other examples.

Instead of providing virtual machines of different processing capacities that are selectable by a tenant, a cloud infrastructure can alternatively or additionally include physical machines of different processing capacities that are selectable by a tenant. As an example, a tenant can select from among a large physical machine, a medium physical machine, and a small physical machine.

Also, the price charged by a provider to a tenant can vary based on a cluster size by the tenant. If the tenant selects a larger number of computing nodes to include in the cluster, then the provider would charge a higher price to the tenant.

A tenant is thus faced with a variety of choices with respect to resources available in the cloud infrastructure, where the different choices are associated with different prices. Intuitively, according to examples discussed above, it may seem that a large virtual machine can execute a workload twice as fast as a medium virtual machine, which in turn can execute a workload twice as fast as a small virtual machine. Similarly, it may seem that as 40-node cluster can execute a workload flair times as fast as a 10-node cluster.

As an example, the provider may charge the same price to a tenant for the following two platform configurations: (1) a 40-node cluster that uses 40 small virtual machines; or (2) a 10-node cluster using 10 large virtual machines. Although it may seem that either platform configuration (1) or (2) may execute a workload of a tenant with the same performance, in actuality, the performance of the workload may differ on platform configurations (1) and (2). The difference in performance of a workload by the different platform configurations may be due to constraints associated with network bandwidth and persistent storage capacity in each platform configuration. A network bandwidth can refer to the available communication bandwidth for performing communications among computing nodes. A persistent storage capacity can refer to the storage capacity available in a persistent storage subsystem.

Increasing the number of computing nodes and the number of virtual machines may not lead to a corresponding increase in persistent storage capacity and network bandwidth. Accordingly, a workload that involves a larger amount of network communications would have a poorer performance in a platform configuration with a larger number of computing nodes and virtual machines, for example. Since the price charged to a tenant depends on the amount of time of resources of a platform configuration used by the tenant, it would be beneficial to select a platform configuration that reduces the amount of time of resource usage of resources of the cloud infrastructure.

The choice of platform configuration in a cloud infrastructure can become even more challenging when a performance objective is to be achieved. For example, one performance objective may be to reduce (or minimize) the overall completion time (referred to as a “makespan”) of the workload.

In accordance with some implementations, techniques or mechanisms are provided to allow for selection of a platform configuration, from among multiple platform configurations, that is able to satisfy an objective of a tenant of a cloud infrastructure. A workload of a tenant can include a number of jobs. Different ordering of the jobs can affect the performance of the workload. Stated differently, a first ordering of the jobs of the workload may complete faster than a second ordering of the jobs of the workload. A specific ordering of jobs of the workload is also referred to as a schedule of the jobs in the workload.

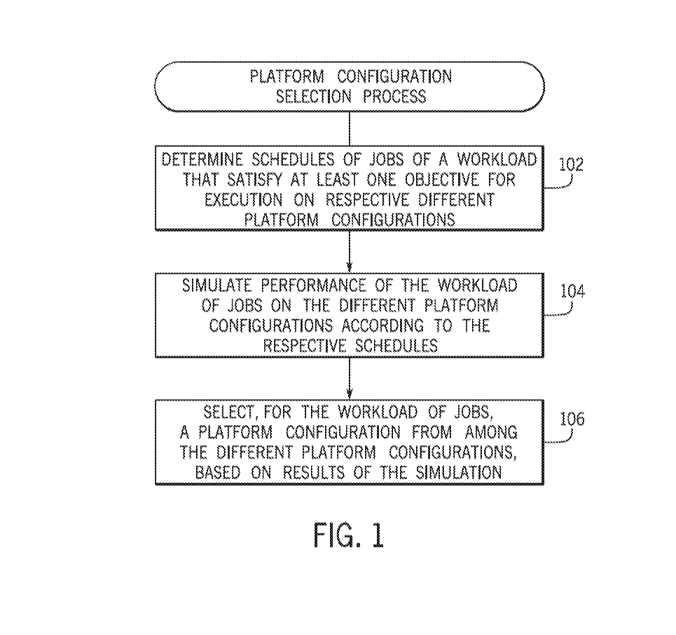

FIG. 1 illustrates a process for selecting a platform configuration for a workload of jobs. The process determines (at 102) schedules of the jobs of the workload that satisfy at least one objective for the workload for execution on respective different platform configurations, where the different platform configurations differ in at least one resource attribute. As examples, platform configurations can differ in cluster size (e.g. number of computing nodes in a cluster) and/or processing capacity size (e.g. size of different virtual machines or physical machines). The at least one objective can include a objective relating to reducing (or minimizing) a time to complete the workload of jobs (i.e. reducing or minimizing the makespan of the workload of jobs).

The process further simulates (at 104) performance of the workload of jobs on the different platform configurations according to the respective schedules. The simulation can be performed by a simulator.

In addition, the process selects (at 106), for the workload jobs, a platform configuration from the different platform configurations, based on results of the simulation. The simulation results can include completion times for the different platform configurations. The platform configuration selected from among the different platform configurations can depend on the problem to be solved. In some implementations, the platform configuration selection solves the following problem: given a target makespan (target completion time) specified by a tenant, select the platform configuration that minimizes the cost (note that each of the different platform configurations is associated with a respective cost). In alternative implementations, the platform configuration selection solves the following problem: given a target cost specified by a tenant, select the platform configuration that minimizes the makespan.

The ability to determine different schedules for the jobs of a workload, and the ability to simulate the workload of jobs on different platform configurations according to the respective schedules, allow for a determination of which platform configuration can be a better platform configuration for the workload of jobs (depending on the problem to be solved). In addition to returning a selected platform configuration that achieves better performance or reduced cost, a proposed schedule of jobs can also be returned by the platform configuration process, in some implementations. This schedule of jobs of the workload can be considered an optimized schedule of jobs of the workload, in some examples.

In some implementations, the jobs of the workload can be MapReduce jobs. MapReduce jobs operate according to a MapReduce framework that provides for parallel processing of large amounts of data. A MapReduce framework includes a distributed arrangement of machines to process requests with respect to data.

A MapReduce job is divided into multiple map tasks and multiple reduce tasks, which can be executed in parallel by computing nodes. The map tasks are defined by a map function, while the reduce tasks are defined by a reduce function. Each of the map and reduce functions can be a user-defined function that is programmable to perform target functionalities. A MapReduce job has a map stage (that includes map tasks and a reduce stage (that includes reduce tasks).

The computing nodes on which map and reduce tasks are performed can be referred to as worker nodes (also referred to as slave nodes). A MapReduce system also includes a master node. MapReduce jobs can be submitted to the master node by various requesters, and the master node can deploy the MapReduce jobs on the worker nodes.

More generally, “map tasks” are used to process input data to output intermediate results, based on a specified map function that defines the processing to be performed by the map tasks. “Reduce tasks” take as input partitions of the intermediate results to produce outputs, based on a specified reduce function that defines the processing to be performed by the reduce tasks. The map tasks are considered to be part of a map stage, whereas the reduce tasks are considered to be part of a reduce stage.

Map tasks are run in map slots of worker nodes, while reduce tasks are run in reduce slots of worker nodes. The map slots and reduce slots are considered the resources used for performing map and reduce tasks. A “slot” can refer to a time slot or alternatively, to some other share of a resource that can be used for performing the respective map or reduce task.

More specifically, in some examples, the map tasks process input key-value pairs to generate a set of intermediate key-value pairs. The reduce tasks produce an output from the intermediate results. For example, the reduce tasks can merge the intermediate values associated with the same intermediate key.

The map function takes input key-value pairs (k₁, v₁) and produces a list of intermediate key-value pairs (k₂, v₂). The intermediate values associated with the same key k₂ are grouped together and then passed to the reduce function. The reduce function takes an intermediate key k₂ with a list of values and processes them to form a new list of values (v₃), as expressed below.

map(k₁, v₁)→list(k₂, v₂).

reduce(k₂, list(v₂))→list(v₃)

The reduce function merges or aggregates the values associated with the same key k₂. The multiple map tasks and multiple reduce tasks are designed to be executed in parallel across resources of a distributed computing platform that makes up a MapReduce system.

Although reference is made to MapReduce jobs in the foregoing, it is noted that techniques or mechanisms according to some implementations can be applied to select platform configurations for workloads that include other types of jobs.

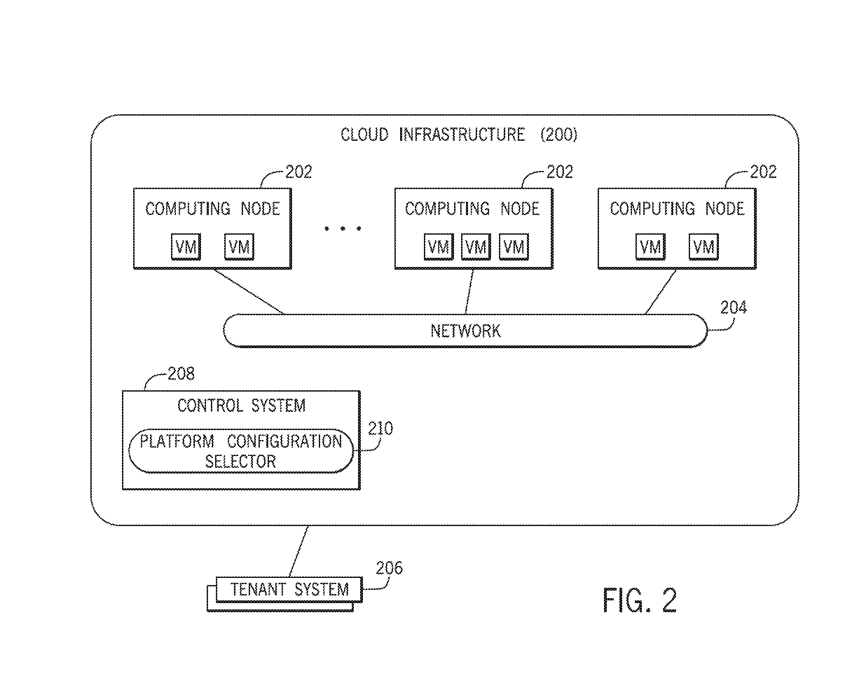

FIG. 2 is a schematic diagram of an example arrangement that includes a cloud infrastructure 200. The cloud infrastructure 200 includes computing nodes 202, and each of the computing nodes includes a number of virtual machines (VMs). The computing nodes 202 are coupled by a network 204.

Tenant systems 206 are coupled to the cloud infrastructure 200. A tenant system 206 can refer to a computer or collection of computers associated with a tenant. Through the tenant system 206, a tenant can submit a request to the cloud infrastructure 200 to rent the resources of the cloud infrastructure 200, including the computing nodes 202 and corresponding virtual machines. A request for resources of the cloud infrastructure 200 can be submitted by a tenant system 206 to a control system 208 of the cloud infrastructure 200. The request can identify a workload of jobs to be performed, and can also specify a target makespan or cost of the tenant.

In accordance with some implementations, the control system 208 includes a platform configuration selector 210 that is able to select a platform configuration, from among multiple platform configurations, in accordance with some implementations, such as according to the process of FIG. 1.

Once the platform configuration is selected by the platform configuration selector 210, the selected resources that are part of the selected platform configuration (including a cluster of computing nodes 202 of a given cluster size, and virtual machines of a given size) are made accessible to the tenant system 206 to perform a workload of the tenant system 206.

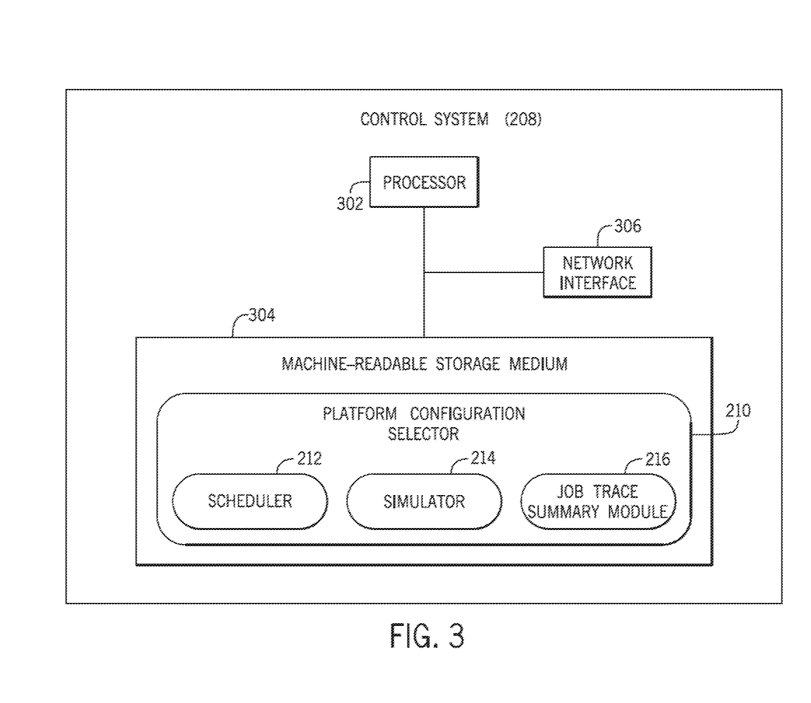

FIG. 3 is a block diagram of components of the control system 208, according to some implementations. The platform configuration selector 210 of the control system 208 includes a scheduler 212 to perform scheduling of jobs of a workload to achieve a target objective. The platform configuration selector 210 also includes a simulator 214 that is able to simulate the execution of jobs of a workload, according to a schedule provided by the scheduler 212, on a candidate platform configuration that includes a given cluster of computing nodes and virtual machines. In addition, the platform configuration selector 210 can include a job trace summary module 216 that is able to produce a job trace summary (discussed further below).

Although the scheduler 212, the simulator 214, and the job trace summary module 216 are depicted as being part of the platform configuration selector 210 in some implementations, it is noted that in other examples, the scheduler 212 and/or the simulator 214 and/or job trace summary module 216 can be separate from the platform configuration selector 210.

The platform configuration selector 210, scheduler 212, simulator 214, and job trace summary module 216 can be implemented as machine-readable instructions executable on one or multiple processors 302 in the control system 208. The control system 208 can be implemented as a computer or a number of computers. The machine-readable instructions forming the platform configuration selector 210, scheduler 212, simulator 214, job trace summary module 216 can be stored in a non-transitory machine-readable or computer-readable storage medium (or storage media) 304.

The processor(s) 302 is (are) coupled to a network interface 306, to allow the control system 208 to communicate over a network, such as a network between the tenant systems 206 and the cloud infrastructure 200.

The following describes further details regarding platform configuration selection according to some implementations.

For a given a set of jobs J (the workload), the platform configuration selector 210 can solve either of the following two problems:
(1) given a target makespan T (a target completion time for the set of jobs J) specified by a tenant, select the instance type (e.g. virtual machine size or physical machine size), the cluster size, and propose a schedule of jobs for meeting the target make span T while minimizing cost; or
(2) given a target cost budget C, select the instance type, the cluster size, and propose the schedule of jobs for the target cost budget C that minimizes the makespan.

As noted above, the platform configuration selector 210 includes or uses the scheduler 210, the simulator 214, and the job trace summary module 216. The job trace summary module 216 produces a job trace summary that includes a summary of a processing trace of each job J, where the processing trace includes N_{M}^{J} map task durations and N_{R}^{J} reduce task durations, where N_{M}^{J} and N_{R}^{J} represent the number of map and reduce tasks, respectively, within each job J. Note that a reduce task can include the following phases:
Shuffle/sort phase: the shuffle/sort phase transfers intermediate data from map tasks to reduce tasks and merge-sorts the transferred data. The shuffling and sorting can be combined because these two sub-phases are interleaved.
Reduce phase: the reduce phase applies the reduce function on the input key and all the values corresponding to the input key.

The job processing trace can be obtained in multiple ways, such as from a past run of a job on the corresponding platform configuration (the job execution can be recorded on an arbitrary cluster size), or extracted from a sample execution of this job on a smaller data set, or interpolated by using a benchmarking approach. The benchmarking approach creates a benchmark, which can include a set of parameters and values assigned to the respective parameters. The parameters of the benchmark can characterize a size of input data, and various characteristics associated with map and reduce tasks.

More generally, a job trace summary represents a set of measured durations of map and reduce tasks of a given job on a given platform configuration. The information of the job trace summary can be created for each of multiple platform configurations, which can differ in instance types (e.g. different sizes of virtual machines or physical machines) and different cluster sizes, for example. Using the job trace summary, a job profile can be computed that reflects the average and maximum durations of map and reduce tasks, respectively, of each job.

The distributions of durations of map and reduce tasks can be used for extracting distribution parameters, and where appropriate, generating scaled traces. A scaled trace refers to a trace for execution on a larger data set, based on a trace obtained from a job execution on a smaller data set. The job traces can be replayed using the simulator 214. Also, the job traces can be used for creating a compact job profile for analytic models, where the compact job profile can include average the average and maximum durations of map and reduce tasks, respectively.

For predicting a completion time of a job, the compact job profile that characterizes job execution during a map phase, shuffle/sort phase, and reduce phase with average and maximum task durations can be used. A model for predicting completion time can evaluate lower bounds T_{J}^{low} and upper bounds T_{J}^{up} on the job completion time. The model can be based a Makespan Theorem for computing performance bounds on the completion time of a given set of n tasks that are processed by k servers (e.g. n map tasks are processed by k map slots in a MapReduce environment). The completion time of the n tasks can be shown to be at least:

$${T}^{low} = avg \cdot \frac{n}{2} - 2 ,$$

and at most

$${T}^{up} = avg \cdot \frac{( n - 1 )}{k} + max ,$$

where avg and max represent the average and maximum durations, respectively, of the n tasks (map tasks or reduce tasks).

The difference between the lower bound T^{low} and upper bound T^{up} represents the range of possible completion times due to task scheduling non-determinism. The average of the lower and upper bounds (T_{J}^{avg}) can be a good approximation of the job completion time. Using the foregoing, the duration of map and reduce stages of a given job can be estimated as a function of allocated resources of a platform configuration.

In some implementations, the scheduler 212 produces a schedule (that includes a specific order of execution of jobs) that reduces (or minimizes) an overall completion time of a given set of jobs. In some examples, a Johnson scheduling technique for identifying an optimal or improved schedule of concurrent jobs can be used. An example of the Johnson scheduling technique is described in S. Johnson, “Optimal Two- and Three-stage Production Schedules with Setup Times Included,” dated May 1953. The Johnson scheduling technique provides a decision rule to determine an optimal scheduling of tasks that are processed in two stages.

In other implementations, other techniques for determining an optimal or improved schedule of jobs can be employed. For example, the determination of the optimal or improved schedule can be accomplished using a brute-force technique, where multiple orders of jobs are considered and the order with the best or better execution time (smallest or smaller execution time) can be selected as the optimal or improved schedule.

The simulator 214 performs a trace replay of jobs in a workload in an order prescribed by a corresponding schedule, as determined by the scheduler 212. The replay of the jobs on a given platform configuration produces results from which the completion time of the jobs and the corresponding cost can be estimated. By varying the platform configuration, the simulator 214 generates a set of performance/cost estimates across different platform configurations. In other words, for each platform configuration of multiple platform configurations, the simulator can produce the following correlation representation that correlates platform configuration parameters (e.g. cluster size and instance type) with the achieved makespan. An example of the simulator 214 that can be used inclues a simulator as described in A. Verma et al., “Play It Again, SimMR!” in Proc. of Intl. IEEE Cluster ‘2011.

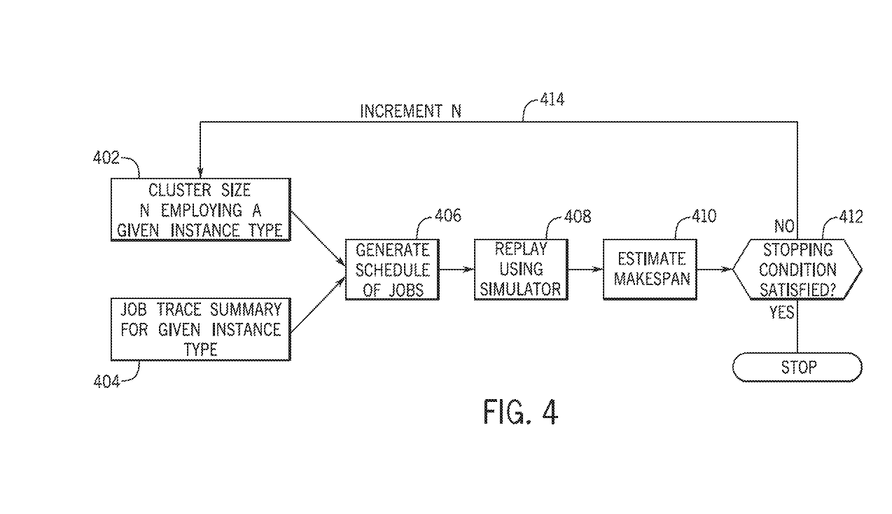

As an example, if the platform configurations of interest employ small, medium, and large VMs, then three respective correlation representations can be produced. FIG. 4 illustrates an iterative process that is performed for each of the small, medium, and large VMs. Inputs of the iterative process include the following: input 402, which specifies a given cluster size N (cluster includes N>1 computing nodes) that employs the given instance type (e.g. small, medium, or large VM); and input 404, which includes a job trace summary for the given instance type. Using the inputs 402 and 404, the scheduler 212 generates (at 406) the respective optimal or improved schedule of jobs of the workload. Then the makespan of the jobs of the workload is obtained by replaying (408) the job traces in the simulator 214 according to the generated schedule. The replaying allows for the achieved makespan (time to complete the workload of jobs) to be estimated (at 410).

Next, if a stopping condition is not satisfied (as determined at 412), the size (N) of the cluster can be incrementally increased (at 414) (e.g. by adding a computing node to the cluster), and the iterative process of FIG. 4 is re-iterated: the scheduler 212 produces a new job schedule for the increased cluster size, and the simulator 214 replays the job traces according to the new schedule to estimate the corresponding makespan. In some examples, a stopping condition can include one of the following: (1) the iterative process is stopped once cluster sizes from a predetermined range of values for a cluster size have been considered; or (2) the iterative process is stopped if an increase in cluster size does not improve the achievable makespan by greater than some specified threshold. The latter condition can happen when the cluster is large enough to accommodate concurrent execution of the jobs of the workload, and consequently, increasing the cluster size cannot improve the makespan by a substantial amount.

The iterative process of FIG. 4 is then performed for another instance type (e.g. another size of virtual machines).

From the performance of iterative processes of FIG. 4 for different instance types and different cluster sizes, a performance-cost data set Data(J) is created based on results of the simulations. Each entry of the data set Data(J) can include the following fields: (InstanceType, NumNodes, Makespan, Cost), where InstanceType specifies the instance type (e.g. virtual machine size), NumNodes specifies the cluster size (number of computing nodes in a cluster), Makespan specifies the estimated makespan of the workload of jobs, and Cost represents the cost of the respective platform configuration (including the respective cluster size and instance type), where the cost can be based on the price charged to a tenant for the respective platform configuration.

As noted above, platform configuration selection can be based on solving one of two problems: (1) given a target makespan T specified by a tenant, select the platform configuration that minimizes the cost; or (2) given a target cost C specified by a tenant, select the platform configuration that minimizes the makespan.

To solve problem (1), the following procedure can be performed.
1) Sort the data set Data(J)=(InstanceType, NumNodes, Makespan, Cost) by the Makespan values in ascending order.
2) Form a subset Data_{Makespan≦T}(J) of the data set Data(J), in which the entries of the subset Data_{Makespan≦T}(J) satisfy Makespan≦T, where T is a target makespan specified by a tenant. Stated differently, the entries of the data set Data(J) whose Makespan values exceed T are not included in the subset Data_{Makespan≦T}(J).
3) Sort the subset Data_{Makespan≦T}(J) by the Cost values in ascending order.
4) Select an entry (or entries) in the subset Data_{Makespan≦T}^{minCost}(J) with the lowest cost. The selected entry (or entries) represent(s) the solution, i.e. a platform configuration of a corresponding instance type and cluster size. Each selected entry is also associated with schedule, which can also be considered to be part of the solution. The solution satisfies the target makespan T while minimizing the cost.

To solve problem (2), the following procedure can be performed.
1) Sort the data set Data(J)=(InstanceType,NumNodes,Makespan,Cost) by the Cost values in ascending order.
2) Form a subset Data^{Cost≦C}(J) including entries of the data set Data(J) that satisfy Cost≦C, where C is the target cost budget specified by a tenant. Stated differently, the entries of the data set Data(J) whose Cost values exceed C are not included in the subset Data^{Cost≦C}(J).
3) Sort the subset Data^{Cost≦C}(J) by the Makespan values in ascending order.
5) Select an entry (or entries) in the subset Data^{Cost≦C}(J) with the lowest makespan. The selected entry (or entries) represent(s) the solution, i.e. a platform configuration of a corresponding instance type and cluster size. Each selected entry is also associated with schedule, which can also be considered to be part of the solution. The solution satisfies the target cost C while minimizing the makespan.

The following further desribes determining a schedule of jobs of a workload, according to some implementations. For a set of MapReduce jobs (with no data dependencies between them), the order in which the jobs are executed may impact the overall processing time, and thus, utilization and the cost of the rented platform configuration (note that the price charged to a tenant can also depend on a length of time that rented resources are used—thus, increasing the processing time can lead to increased cost).

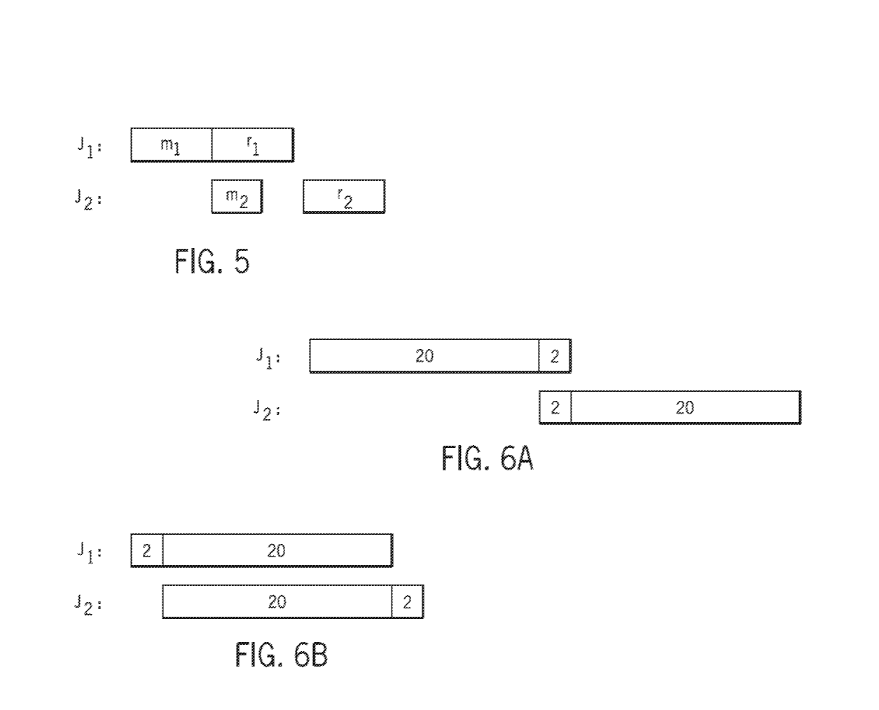

The following considers an example execution of two (independent) MapReduce jobs J₁ and J₂ in a cluster, in which no data dependencies exist between the jobs. As shown in FIG. 5, once the map stage (m₁) of J₁ completes, the reduce stage (r₁) of job J₁ can begin processing. Also, the execution of the map stage (m₂) of the next job J₂ can begin execution, by using the map resources released due to completion of the map stage (m₁) of J₁. Once the map stage (m₂) of the next job J₂ completes, the reduce stage (j₂) of the next job J₂ can begin. As shown in FIG. 5, there is an overlap in executions of map stage (m₂) of job J₂ and the reduce stage (r₁) of job J₁.

A first execution order of the jobs may lead to a less efficient resource usage and an increased processing time as empared to a second execution of the jobs. To illustrate this, consider an example workload that includes the following two jobs:
Job J₁=(m₁, r₁)=(20 s, 2 s) (map stage has a duration of 20 seconds, and reduce stage has a duration of two seconds).
Job J₂=(m₂, r₂)=(2 s, 20 s) (map stage has a duration of two seconds, and reduce stage has a duration of 20 seconds).

There are two possible execution orders for jobs J₁ and J₂ shown in FIGS. 6A and 6B:
J₁ is followed by J₂ (FIG. 6A). In this execution order, the overlap of the reduce stage of J₁ with the map stage of J₂ extends two seconds. As a result, the total completion time of processing jobs J₁ and J₂ is 20 s+2 s+20 s=42 s.
J₂ is followed by J₁ (FIG. 6B). In this execution order, the overlap of the reduce stage of J₂ with the map stage of J₁ extends 20 seconds. As a result, the total completion time is 2 s+20 s+2 s=24 s, which is less than the first execution order.

More generally, there can be a substantial difference in the job completion time depending on the execution order of the jobs of a workload. A workload [symbol] ={J₁,J₂, . . . , Jₙ} includes a set of n MapReduce jobs with no data dependencies between them. The scheduler 214 generates an order (a schedule) of execution of jobs Jᵢ ∈ [symbol] such that the makespan of the workload is minimized. For minimizing the makespan of the workload of jobs [symbol] ={J₁,J₂, . . . , Jₙ}, the Johnson scheduling technique discussed above can be used.

Each job Jᵢ in the workload [symbol] of n jobs can be represented by the pair (mᵢ, rᵢ) of map and reduce stage durations, respectively. The values of mᵢ and rᵢ can be estimated using lower and upper bounds, as discussed above, in some examples. Each job Jᵢ=(mᵢ,rᵢ) can be augmented with an attribute Dᵢ that is defined as follows:

$${D}_{i} = \{ \begin{matrix}( {m}_{i} , m ) & if min ( {m}_{i} , {r}_{i} ) = {m}_{i} , \\ ( {r}_{i} , r ) & otherwise .\end{matrix}$$

The first argument in Dᵢ is referred to as the stage duration and denoted as Dᵢ¹. The second argument in Dᵢ is referred to as the stage type (map or reduce) and denoted as Dᵢ². In the above, (m, m), mᵢ represents the duration of the map stage, and m denotes that the type of the stage is a map stage. Similarly, in (rᵢ, r), rᵢ represents the duration of the reduce stage, and r denotes that the type of the stage is a reduce stage.

An example pseudocode of the Johnson scheduling technique is provided below.

Johnson scheduling technique

| Input: A set [symbol] of n MapReduce jobs. Dᵢ is the attribute of job Jᵢ as | |
|---|---|
| defined above. | |
| Output: Schedule σ (order of execution of jobs). | |
| 1: | Sort the set [symbol] of jobs into an ordered list L using their stage |
| | duration attribute Dᵢ¹ |
| 2: | head ← 1, tail ← n |
| 3: | for each job Jᵢ in L do |

| | |
|---|---|
| 4: | if Dᵢ² = m then |

| | |
|---|---|
| 5: | // Put job Jᵢ from the front |
| 6: | σ_{head} ← Jᵢ, head ← head + 1 |

| | |
|---|---|
| 7: | else |

| | |
|---|---|
| 8: | // Put job Jᵢ from the end |
| 9: | σₜₐᵢₗ ← Jᵢ, tail ← tail − 1 |

| | |
|---|---|
| 10: | end if |

| | |
|---|---|
| 11: | end for |

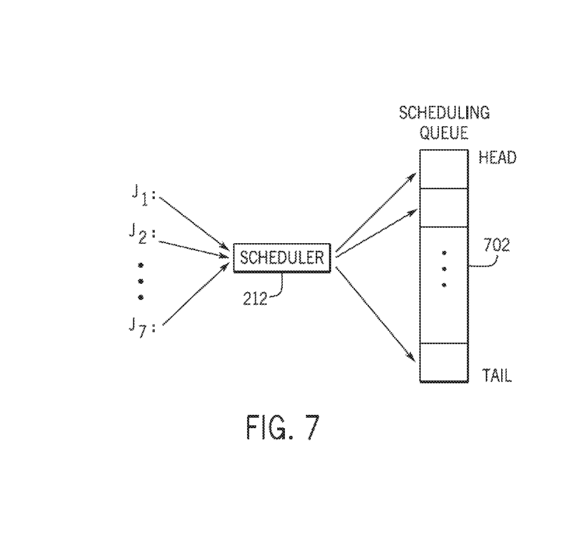

The Johnson scheduling technique (as performed by the scheduler 212) depicted above is discussed in connection with FIG. 7, which shows an scheduling queue 702 that includes a number of entries in which jobs of the set [symbol] of jobs are to be placed. Once the scheduling queue 702 is filled, then the jobs in the scheduling queue 702 can be executed in an order from the head (head) of the queue 702 to the tail (tail) of the queue 702. At line 2 of the pseudocode, head is initialized to the value 1, and tail is initialized to the value n (n is the number of jobs in the set [symbol] ).

Line 1 of the pseudocode sorts the n jobs of the set [symbol] in the ordered list L in such a way that job Jᵢ precedes job Jₜ₊₁ in the ordered list L if and only if min(mᵢ,rᵢ)≦min(mᵢ₊₁, rᵢ₊₁). In other words, the jobs are sorted using the stage duration attribute Dᵢ¹ in Dᵢ (stage duration attribute Dᵢ¹ represents the smallest duration of the two stages).

The pseudocode takes jobs from the ordered list L and places them into the schedule σ (represented by the scheduling queue 702) from the two ends (head and tail), and then proceeds to place further jobs from the ordered list L in the intermediate positions of the scheduling queue 702. As specified at lines 4-6 of the pseudocode, if the stage type Dᵢ² in Dᵢ is m, i.e. Dᵢ² represents the map stage type, then job Jᵢ is placed at the current available head of the scheduling queue 702 (as represented by head, which is initiated to the value 1. Once job J₁ is placed in the scheduling queue 702, the value of head is incremented by 1 (so that a next job would be placed at the next head position of the scheduling queue 702).

As specified at lines 7-9 of the pseduocode, if the stage type Dᵢ² in Dᵢ is not m, then job Jᵢ is placed at the current available tail of the scheduling queue 702 (as represented by tail, which is initiated to the value n. Once job Jᵢ is placed in the scheduling queue 702, the value of tail is incremented by 1 (so that a next job would be placed at the next tail position of the scheduling queue 702).

Techniques or mechanisms according to some implementations allow platform configurations and schedules to be selected for respective workloads that improve performance of the workloads and reduce costs.

Machine-readable instructions of various modules described above (including the platform configuration selector 210, scheduler 212, simulator 214, and job trace summary module 216 of FIGS. 2 and 3) are loaded for execution on a processor. A processor can include a microprocessor, microcontroller, processor module or subsystem, programmable integrated circuit, programmable gate array, or another control or computing device.

Data and instructions are stored in respective storage devices, which are implemented as respective non-transitory computer-readable or machine-readable storage media. The storage media can include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
determining, by a system including a processor, schedules that satisfy at least one objective for a workload of jobs for execution on respective different platform configurations, wherein the different platform configurations differ in at least one resource attribute;
simulating, by the system, performance of the workload of jobs on the different platform configurations according to the respective schedules; and
selecting, by the system for the workload of jobs, a platform configuration from the different platform configurations, based on results of the simulation.

2. The method of claim 1, wherein determining the schedules that satisfy the at least one objective comprises determining the schedules that minimizes a time to complete the workload of jobs.

3. The method of claim 2, wherein a time to complete the workload of jobs differs depending upon which of the different platform configurations the workload of jobs is used to execute the workload of jobs.

4. The method of claim 1, wherein a first of the schedules of the workload of jobs determined for a first of the different platform configurations has an order of the jobs that is different from an order of the jobs of a second of the schedules of the workload of jobs determined for a second of the different platform configurations.

5. The method of claim 1, wherein the at least one resource attribute includes a size of a cluster of nodes.

6. The method of claim 1, wherein the at least one resource attribute includes an allocation of processing capacity.

7. The method of claim 6, wherein the allocation of processing capacity includes a size of a virtual machine or a size of a physical machine.

8. The method of claim 1, wherein the workload of jobs includes a workload of MapReduce jobs.

9. The method of claim 1, further comprising collecting, based on the results of the simulation, a data set including entries corresponding to the different platform configurations, each entry of the data set correlating a respective one of the different platform configurations to a corresponding completion time of the workload of jobs and a cost of the respective platform configuration.

10. A system comprising:
at least one processor;
a scheduler executable on the at least one processor to generate schedules of jobs of a workload that satisfy at least one objective for respective different platform configurations of a cloud infrastructure, wherein the different platform configurations differ in at least one resource attribute, the at least one resource attribute selected from among a number of nodes and a capacity of a processing resource;
a simulator executable on the at least one processor to replay the jobs on each of the different platform configurations according to the respective schedules; and
a platform configuration selector executable on the at least one processor to select one of the different platform configurations using results of replaying the jobs.

11. The system of claim 10, wherein the platform configuration selector is to select one of the different platform configurations in response to a request of a tenant of the cloud infrastructure.

12. The system of claim 11, wherein the request specifies a target completion time, and wherein the platform configuration selector is to select one of the different platform configurations that is able to meet the target completion time, while minimizing a cost.

13. The system of claim 11, wherein the request specifies a target cost, and wherein the platform configuration selector is to select one of the different platform configurations that is able to meet the target cost, while minimizing a completion time of the jobs of the workload.

14. An article comprising at least one non-transitory machine-readable storage medium storing instructions that upon execution cause a cloud infrastructure to:
receive, from a tenant system, a request for resources of the cloud infrastructure, the request specifying a target completion time or cost;
determine schedules that satisfy at least one objective for a workload of jobs for execution on respective different platform configurations, wherein the different platform configurations differ in at least one resource attribute;
simulate performance of the workload of jobs on the different platform configurations according to the respective schedules; and
select, for the workload of jobs, a platform configuration from the different platform configurations, based on results of the simulation, the selected platform configuration satisfying the target completion time or cost.

15. The article of claim 14, wherein the at least one resource attribute is selected from among a number of nodes, a capacity of a virtual machine, and a capacity of a physical machine.
